(19) United States
(12) Patent Application Publication
(10) Pub. No.: US 2002/0002596 A1
(43) Pub. Date: Jan. 3, 2002

(54) APPARATUS AND METHOD FOR RETRIEVING INFORMATION OVER A COMPUTER NETWORK

(75) Inventors: BASUKI AFANDI SUGIARTO, SAN DIEGO, CA (US); CLAYTON R. KARMEL, SAN JOSE, CA (US)

Correspondence Address: FROMMER LAWRENCE & HAUG, 745 FIFTH AVENUE- 10TH FL., NEW YORK, NY, 10151, US

(73) Assignee: Sony Corporation

(21) Appl. No.: 09/146,717

(22) Filed: Sep. 3, 1998

(51) Int. Cl. G06F 15/16

(52) U.S. Cl. 709/218

(57) ABSTRACT

Personalized information retrieval from a network is enabled through a user configuration file which is created and/or edited by the user and stored in a database server. The file specifies what information the user would like to retrieve from the network and how that information is to be displayed. When a user attempts to retrieve information from the network, a system server responds to the request by uploading one or more request-servicing software modules, identifying the requesting user, and retrieving the user's configuration file from the database server. The system server then retrieves and formats network information in accordance with the configuration file. Finally, the formatted information is forwarded to the user's access device for display. By providing network users with a personalized information retrieval scheme, the invention allows each user to tailor the retrieval of information to the user's personal needs and to the capabilities of the user's network access device.

### FIELD OF THE INVENTION

This invention relates to computer networks, and more particularly to customizing the retrieval of information over a computer network.

### BACKGROUND OF THE INVENTION

The advent of computer networks and the increasing amount of information that is available over those networks has given rise to a growing number of network users. Traditionally, users gained access to computer networks through mainframe or desktop computers. However, in order to meet the varying needs of individual users, many alternative systems for accessing computer networks have been developed. For example, devices commonly known as “palm-top computers”, which are not much bigger than cellular telephones, often come equipped with internet access capability.

Accordingly, designers of network access systems must consider how their systems will accommodate the varying users and user access devices. That is, designers must consider how to gather and present network information given a user's needs and the capabilities of the user's access device. For example, designers must consider how internet information—which is most commonly provided in the form of “web pages”—can be efficiently retrieved and displayed to meet a particular user's needs.

### OBJECTS AND SUMMARY OF THE INVENTION

It has been recognized that the efficient retrieval and display of computer network information is facilitated by allowing a network user to customize the retrieval and display according to the user's needs.

Accordingly, it is an object of the present invention to provide a network access system that allows users to customize the retrieval and display of network information. It is a more particular object of the invention to allow users of highly portable internet access devices (hereinafter referred to as “handsets”) to specify what information is retrieved from the internet and how that information is displayed.

In accordance with the invention, personalized information retrieval from a network is enabled through a user configuration file. The configuration file is created by the user and is stored in a database server. It specifies what information the user would like to retrieve from the network and how that information is to be displayed. When a user attempts to retrieve information from the network, a system server responds to the request by uploading one or more request-servicing software modules, identifying the requesting user, and retrieving the user's configuration file from the database server. The requested information is formatted in accordance with the user's configuration file and forwarded to the user's access device for display.

By providing network users with a personalized information retrieval scheme, the invention allows each user to tailor the retrieval of information to the user's personal needs and to the capabilities of the user's network access device.

### BRIEF DESCRIPTION OF THE DRAWINGS

The following detailed description, given by way of example and not intended to limit the present invention solely thereto, will best be appreciated in conjunction with the accompanying drawings, in which:

FIG. 1 shows an information retrieval system in accordance with a preferred embodiment of the invention.

FIG. 2 shows an example of a display screen that may be used during configuration file editing according to the present invention.

FIG. 3 shows an example of a “personalized page” in accordance with the present invention.

FIGS. 4-6 show examples of web pages from which information is culled to form the exemplary personalized page of FIG. 3.

### DETAILED DESCRIPTION OF CERTAIN PREFERRED EMBODIMENTS

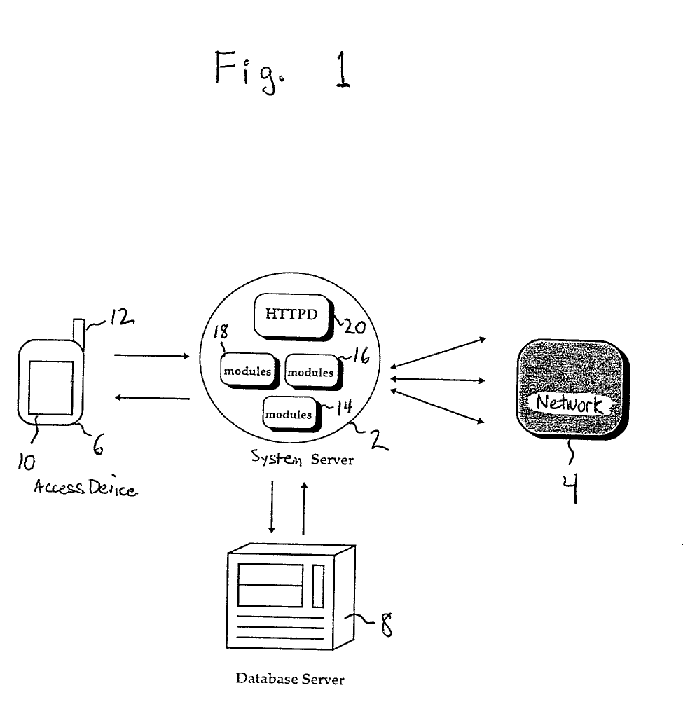

FIG. 1 shows an information retrieval system in accordance with a preferred embodiment of the invention. As can be seen from the figure, the system includes a system server 2 that is coupled to a computer network 4. The coupling of the system server and network may take many forms, for example, a telephone wire, a coaxial cable, a twisted-pair wire, a fiber optic link, and/or a wireless link. Also coupled to the system server are a user access device 6 and a database server 8. Like the network coupling, the user access device coupling and database coupling may take various forms.

The user access device may be a desktop computer, a laptop computer, a cellular telephone, a personal organizer, a palm-top computer, or any other device that is equipped for communication with the system server. Although there are many possible embodiments for the user access device, for purposes of the following description the user access device will be considered to be a hand-held portable access device (e.g., a palmtop computer) and will be referred to as a “handset”.

The handset depicted in FIG. 1 includes a display screen 10 and an antenna 12. The display screen may be used to display information retrieved from the network through the system server, as well as information pertaining to the use of the handset itself, such as the handset's battery level. The antenna allows the handset to communicate with the system server when the two are coupled by a wireless link.

The database server of FIG. 1 may be any system capable of electronically storing data including, but not limited to systems that store data on optical disks, magnetic disks, and magnetic tape.

The network in FIG. 1 may be the internet, a local area network (LAN), or any other network that enables the transfer of data. For purposes of describing a preferred embodiment of the invention, the network will be presumed to be the internet. Furthermore, the description will be focused on the world-wide-web aspect of the internet. Accordingly, to facilitate understanding of the invention it should be noted that current world-wide-web operation groups information into “web-pages”; and that the standard format for such pages is the “HTML” format, which enables a web user to create “hypertext links” through the “HTTP” protocol.

The system server is central to the invention's operation. It is depicted in FIG. 1 as being a collection of software modules 14-20. These modules may be software modules that reside within a single computer, or alternatively, may be distributed among multiple computers. Module 20 is an “HTTP daemon” which runs in the background of the system control software and which is capable of enabling access to HTTP facilities. Modules 14, 16 and 18 are request-servicing modules. When the daemon receives an information request it uploads into module 20 one of the request-servicing modules 14 and the uploaded module then carries out the processing necessary to honor the request.

Having described an information retrieval system configuration in accordance with the invention, the operation of the system will now be described in detail.

Personalized information retrieval according to the invention is enabled through configuration files. Each system user has an associated configuration file which is stored in the database server 8. The configuration file specifies what information the user would like to retrieve and how that information is to be formatted. Thus, for example, a user may want to retrieve information from three different internet web pages, the CNN web page, the ESPN web page, and the NASDAQ web page. Further, the user may want to retrieve specific information from each page, and may want all the information retrieved from the pages to be formatted such that it can be displayed within one display screen of the handset. That is, the user may want “Headline News” from the CNN page, particular stock quotes from the NASDAQ page, and the latest score for a particular sports team from the ESPN page, and may want these items displayed simultaneously on the handset screen. Accordingly, the configuration file is created/edited to retrieve and format the specified CNN, NASDAQ and ESPN information, and then is stored in the database server.

The configuration file may be created and/or edited by the user, or by a service provider. In either case, the file may be created through the same device that will be used to view the retrieved information, or through some other device. In a typical scenario, the user edits the configuration file using a desktop computer and transfers the edited file to the database server for use with the handset.

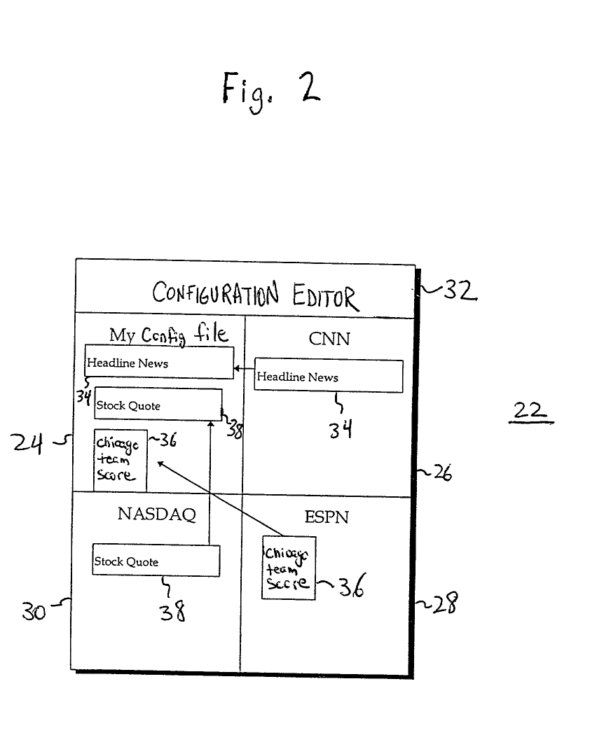

There are several programming technologies that may be used to perform configuration file editing. Among them are: Netscape Navigator Plug-Ins, which provide a plug-in module that is embedded within the Navigator browser; Netscape Composer Plug-Ins, which provide a plug-in module embedded within Netscape Composer; and Microsoft ActiveX, which provides complete programming control for windows applications. Any of these technologies may be used to design a configuration file editor that will allow users to modify the “look and feel” of their personalized information retrieval. Preferably, the configuration file editor has a WYSIWYG (What You See Is What You Get) feature, an example of which is illustrated in FIG. 2. Alternative systems and techniques for performing configuration file editing are discussed in co-pending, commonly assigned, U.S. patent application Ser. No.: ______ (Attorney Docket No. 450103-4450)—entitled Apparatus and Method for Designating Information to be Retrieved Over a Computer Network—which application is incorporated herein by reference.

FIG. 2 shows a display screen 22 of a configuration file editing platform during WYSIWYG type editing. The screen is divided into five portions 24, 26, 28, 30 and 32. Portion 32 is a screen header which includes general information, such as an indication that the screen pertains to a configuration editor. Portions 24-30 are used to provide “drag and drop” style WYSIWYG editing by letting the user drag and drop images, HTML tables, hypertext links, applets, etc. from one portion to another. More specifically, the user selects items from portions 26, 28 and 30, which represent the contents of various web pages, and drags and drops the items in portion 24, which represents the contents of the user's configuration file. In the illustrated embodiment, the user edits the configuration file by: selecting item 34 (Headline News) from the CNN portion and dragging and dropping it in the configuration file portion; selecting item 36 (Chicago Team Score) from the ESPN portion and dragging and dropping it in the configuration file; and selecting item 38 (Stock Quote) from the NASDAQ portion and dragging and dropping it in the configuration file. As an added feature, configuration file portion 24 of screen 22 may be set to the size of the access device display, so that the user can see how the display will look following an actual information retrieval.

Upon completion of configuration file editing, the file is sent to the system server to verify any hypertext links that are embedded in the file. If all hypertext links are verified, the system server stores the configuration file in the database server, otherwise the system server notifies the editing platform that one or more hypertext links could not be reached (e.g., an intranet web server behind a corporate firewall). Once the configuration file is stored in the database server, the system is prepared to honor information requests.

The user initiates a request through handset 6 of FIG. 1. One way the handset can provide this function is via a “pull-down” menu that opens up a hypertext link connection to the system server through HTTP protocol. For instance, the handset may open up the connection by using a special flag, such as “http://access.domain/pir” (the “pir” standing for “personal information request”). Alternatively, the handset may open the connection by using a unique IP address. In any event, the user is responsible only for opening a personalized information request connection and for receiving the information as specified in the user's configuration file. The remainder of the necessary processing is performed by the system server.

As mentioned above, the system server includes an HTTP daemon which runs in the background of the system control software and functions to recognize and service user information requests. When the system server recognizes a request through the daemon it uploads the appropriate request-servicing software module (elements 14, 16 and 18 of FIG. 1), identifies the requesting user, and retrieves the user's configuration file from the database server. Depending on the information contained in the user's configuration file, the uploaded module opens up the appropriate HTTP connections, fetches the appropriate web pages from the internet, and formats them into a single page that is viewable on the handset. Finally, the formatted page is transmitted to the handset for viewing by the user and the uploaded module notifies the HTTP daemon that the request has been honored.

There are several Web Proxy server technologies suitable for implementing the daemon-module scheme of the system server. These include the Netscape Web Proxy Server, Spyglass Prism, and Apache.

By implementing the invention through a daemon-module scheme as opposed to a Common Gateway Interface (CGI) scheme, several benefits are realized. For one, the modules of the present invention may be made substantially smaller than comparable CGI software, thereby conserving system memory. Also, since the modules are smaller than comparable CGI software and are integrated within the HTTP daemon, they can be uploaded from their storage location to the computer on which they run in less time than it would take to upload the comparable CGI software. Moreover, the modules can be uploaded at any time, even if there are no requests, and they do not have to be shutdown following a request. Thus, the modules can be kept at the ready in memory and the process throughput can be increased. Still another benefit is that various types of modules can be inserted into the HTTP daemon, such as modules that perform web statistic analysis, web censorship, image conversion and encryption.

At this point, it should be noted that the user is not limited to viewing only the formatted page (e.g. the formatted page depicted in FIG. 2 as element 24). For instance, once a formatted page is received, the user may select (or “click on”) one of the items in the page (e.g. FIG. 2, item 34—“Headline News”) to request additional information concerning that item. An example of how to provide such a service is to include hypertext links in the information of the formatted page. The user can then use the hypertext links to request display of web pages containing information supplementary to the information of the formatted page. An alternative approach to providing the service is to respectively link one or more items in the formatted page to one or more second formatted pages. Thus, for example, a user may create a second formatted page including items such as “Headline Financial News”, “Headline Sports News”, and “Headline Science News”, and thereafter this second formatted page is retrieved in response to a selection of “Headline News” in the first formatted page. Of course, it is possible to link any second formatted page to one or more third formatted pages, and so on.

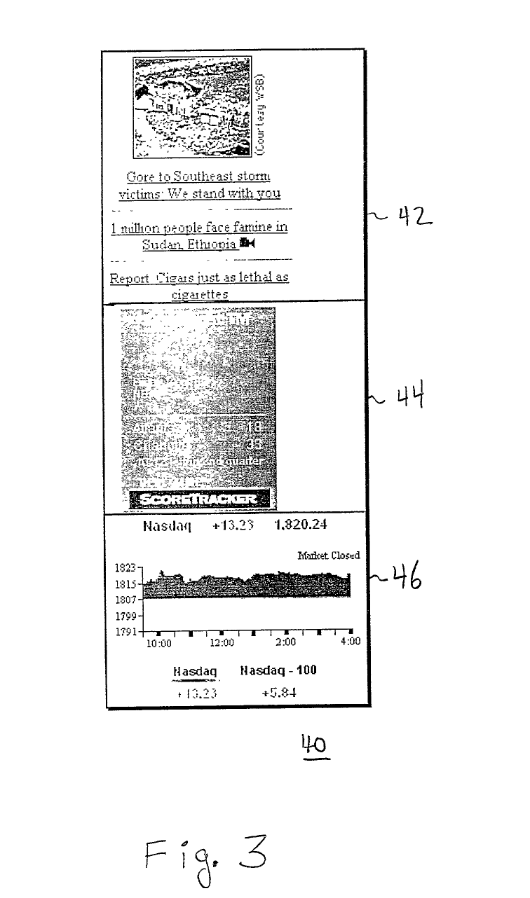

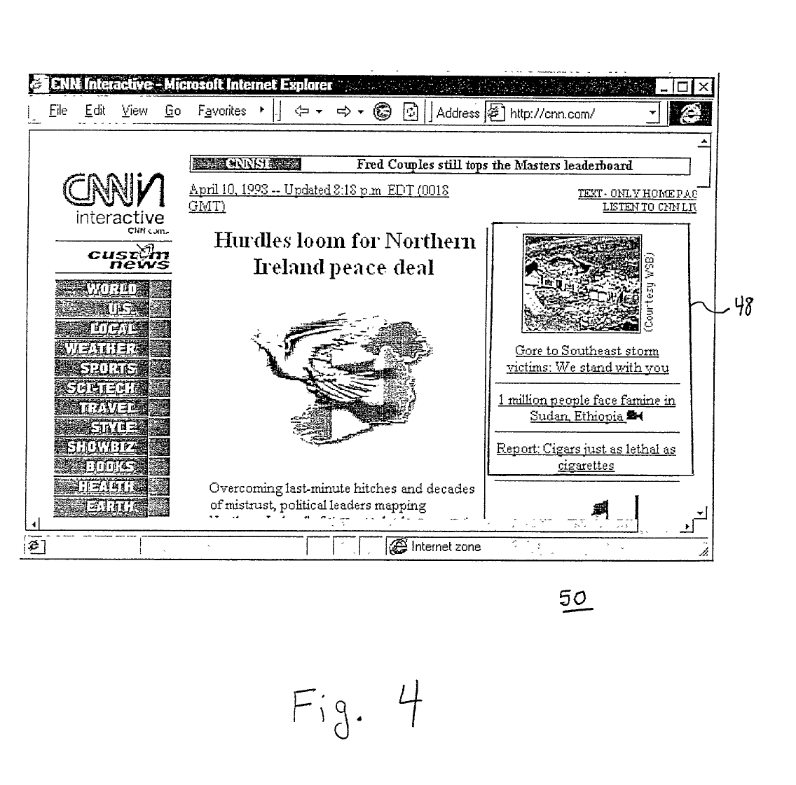

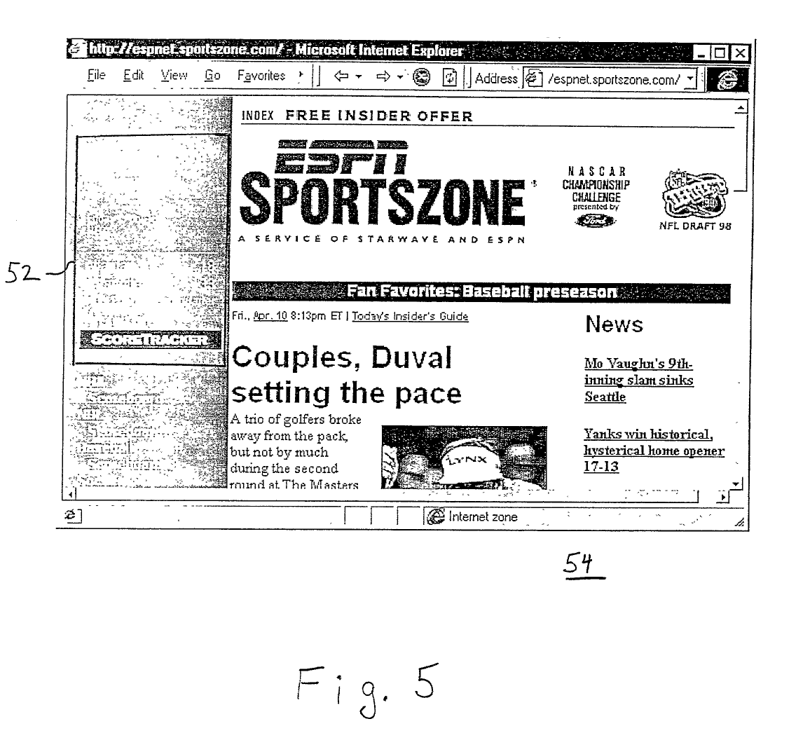

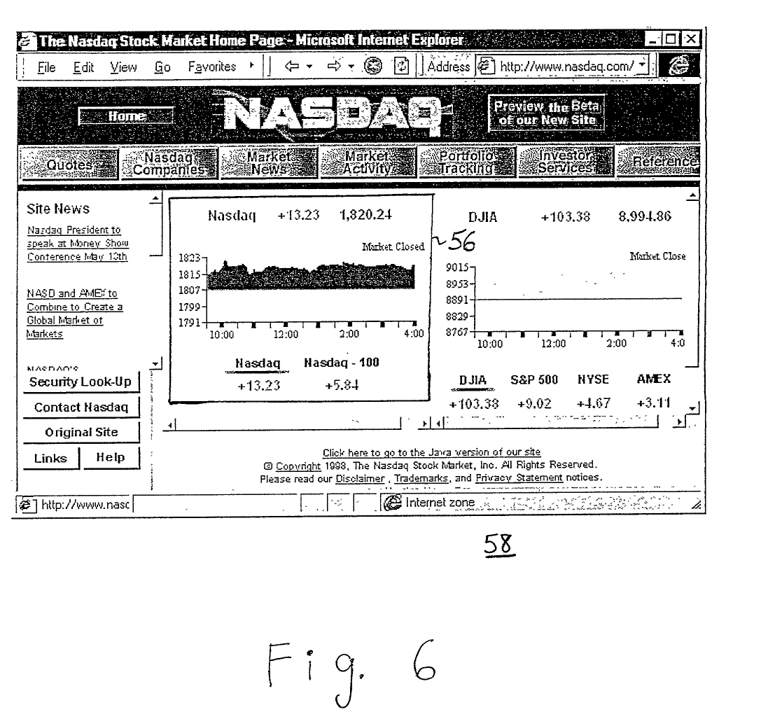

An example of a formatted (or “personalized”) page in accordance with the invention is shown in FIG. 3. The formatted page of FIG. 3 incorporates information from three different web pages, a CNN web page (illustrated in FIG. 4), an ESPN web page (illustrated in FIG. 5) and a NASDAQ web page (illustrated in FIG. 6). As can be seen from the figures, the formatted page 40 is made up of three portions, a CNN portion 42, an ESPN portion 44 and a NASDAQ portion 46. These portions are culled from their respective web pages. That is, the CNN portion 42, ESPN portion 44 and NASDAQ portion 46 of the formatted page correspond respectively to portion 48 of CNN web page 50, portion 52 of ESPN web page 54 and portion 56 of NASDAQ web page 58—the layout and content of the formatted page having been determined according to the abovedescribed configuration file creation/editing operation.

While the present invention has been particularly shown and described in conjunction with preferred embodiments thereof, it will be readily appreciated by those of ordinary skill in the art that various changes may be made without departing from the spirit and scope of the invention. For example, although the invention has been described in the context of a user having a single configuration file, it is possible for any one user to have more than one configuration file, the individual configuration files being invoked by distinct user commands so as to specify distinct retrieval parameters. Furthermore, although the display screen 22 of FIG. 2 is described as occupying the entire editor platform display, this is not a requirement (e.g., the editor screen may be positioned within a window that is part of the overall display).

Therefore, it is intended that the appended claims be interpreted as including the embodiments described herein, the alternatives mentioned above, and all equivalents thereto.

What is claimed is:

1. A system for retrieving information from a network and forwarding the retrieved information to a user access device, comprising:
means for storing one or more user configuration files, each said configuration file being associated with a user, specifying one or more types of information to be retrieved, and specifying how the retrieved information is to be formatted; and
means for responding to an information request from a requesting user by associating said information request with said requesting user, retrieving one of said configuration files corresponding to said requesting user, retrieving and formatting information from the network in accordance with said corresponding configuration file, and forwarding said formatted information to the access device of said requesting user.

2. The system according to claim 1, wherein said network is the internet, said retrieved information includes information from a multiple of internet web pages, and said retrieved information is formatted so that it can be viewed in a single display screen of said requesting user access device.

3. The system according to claim 1, wherein said requesting user access device is a hand-held portable device that is coupled to said means for responding via a wireless link.

4. The system according to claim 1, wherein said means for responding comprises at least one computer that runs an HTTP daemon and a multiple of software modules, and wherein said daemon responds to said information request by uploading one or more of said software modules.

5. The system according to claim 1, further comprising means for enabling a user to create/edit his respective configuration files.

6. The system according to claim 5, wherein said means for enabling includes means for enabling said user to create/edit his respective configuration files via a drag and drop type interface.

7. The system according to claim 1, wherein said means for storing is a magnetic disc storage device.

8. The system according to claim 1, wherein said information request is initiated by opening a hypertext link connection between said requesting user access device and said means for responding.

9. A method for retrieving information from a network and forwarding the retrieved information to a user access device, comprising the steps of:
storing one or more user configuration files in a storage means, each said configuration file being associated with a user, specifying one or more types of information to be retrieved, and specifying how the retrieved information is to be formatted; and
responding to an information request from a requesting user by associating said information request with said requesting user, retrieving one of said configuration files corresponding to said requesting user, retrieving and formatting information from the network in accordance with said corresponding configuration file, and forwarding said formatted information to the access device of said requesting user.

10. The method according to claim 9, wherein said network is the internet, said retrieved information includes information from a multiple of internet web pages, and said retrieved information is formatted so that it can be viewed in a single display screen of said requesting user access device.

11. The method according to claim 9, wherein said requesting user access device is a hand-held portable device that is coupled to said means for responding via a wireless link.

12. The system according to claim 9, wherein said step of responding to said information request comprises the step of using an HTTP daemon to recognize said request and upload one or more of software modules in response to said request.

13. The method according to claim 9, further comprising the step of enabling a user to create/edit his respective configuration files.

14. The method according to claim 13, wherein said user creates/edits his respective configuration files via a drag and drop type interface.

15. The method according to claim 9, wherein said configuration file is stored on a magnetic disc storage device.

16. The method according to claim 9, wherein said information request is initiated by opening a hypertext link connection to said requesting user access device.
